(19) United States
(12) Patent Application Publication
(10) Pub. No.: US 2008/0236328 A1
(43) Pub. Date: Oct. 2, 2008

(54) Steering Wheel Mounting Assembly

(76) Inventors: Xiaolan Ai, Massillon, OH (US); David A. Degrange, Massillon, OH (US)

Correspondence Address: MICHAEL BEST & FRIEDRICH LLP, 100 E WISCONSIN AVENUE, Suite 3300, MILWAUKEE, WI, 53202, US

(21) Appl. No.: 10/593,733

(22) PCT Filed: Mar. 24, 2005
(86) PCT No.: PCT/US05/09857

§ 371 Date: Sep. 21, 2006

Related U.S. Application Data
(60) Provisional application No. 60/556,278, filed on Mar. 25, 2004.

(51) Int. Cl. B62D 1/10; G06F 17/00

(52) U.S. Cl. 74/552; 701/41

(57) ABSTRACT

A steering wheel mounting assembly comprising first and second stationary rings, the second stationary ring being adapted for connection to a vehicle frame. The assembly further comprises a steering hub having a spindle with a radial flange extending therefrom. The spindle is adapted for connection with a steering shaft and the radial flange is adapted for connection with a steering wheel. The spindle has a first bearing raceway for engaging a bearing of the first stationary ring and a second bearing raceway for engaging a bearing of the second stationary ring. The steering hub has at least one opening that defines a bearing surface. A friction roller assembly, having a shaft with a third bearing thereabout, is positioned in the opening such that as the third bearing rotates relative to the bearing surface, the third bearing moves radially outward and the shaft engages the first and second cylindrical raceways.

### BACKGROUND

The present invention relates to a steering assembly. More particularly, the present invention relates to a steering assembly having a steering hub mounted to a steering wheel.

Referring to FIG. 1, a prior art steering assembly 10 is shown. The steering assembly 10 includes a steering wheel 12 mounted on a radial frame 14. The radial frame 14 includes a central hub 16 that is mounted on a steering shaft 18. Rotation of the steering wheel 12 is translated through the frame 14, and thereby the hub 16, to cause rotation of the steering shaft 18.

A mounting frame 20 is attached to and rotates with the radial frame 14. The mounting frame 20 is configured to support an air bag assembly 22 and other components. The air bag assembly 22 is fixed to the mounting frame 20, and therefore, rotates with the steering wheel 12. Since the orientation of the air bag assembly 22 continuously changes with rotation of the steering wheel 12, the air bag assembly 22 must have a substantially symmetrical design so that the air bag thereof will deploy with a known configuration no matter the orientation of the air bag assembly 22 at the time of deployment.

Furthermore, it is not desirable to mount driver controls and displays on the mounting frame 20 since the mounting frame 20 rotates with the steering wheel 12.

### SUMMARY

The present invention relates to a steering wheel mounting assembly. The assembly comprises first and second stationary rings. The first stationary ring has a first bearing and a first cylindrical raceway. The second stationary ring has a second bearing and a second cylindrical raceway and is adapted to be fixed to a vehicle frame. The assembly further comprises a steering hub having a spindle with a radial flange extending therefrom. The spindle is adapted for connection with a steering shaft, and the radial flange is adapted for connection with a steering wheel. The spindle has a first bearing raceway for engaging the first bearing and a second bearing raceway for engaging the second bearing. The steering hub has at least one opening through the steering hub radial flange. The opening defines a bearing surface. A friction roller assembly is positioned in the opening. The friction roller assembly has a shaft with a third bearing thereabout. The friction roller assembly is positioned in the opening such that the third bearing rotates relative to the bearing surface, the third bearing moves radially outward, and the shaft engages the first and second cylindrical raceways.

### BRIEF DESCRIPTION OF THE DRAWINGS

FIG. 1 is a side elevation of a prior art steering assembly in partial cross section;

FIG. 2 is an exploded, isometric view of a mounting assembly that is a first embodiment of the present invention;

FIG. 3 is an isometric view, in section, of a stationary ring of the present embodiment of the invention;

FIG. 4 is an assembled, isometric view of the mounting assembly of FIG. 2 in cross section;

FIG. 5 is a front elevation view, in partial section, of the assembled mounting assembly of FIG. 2;

FIG. 6 is a cross sectional view along the line 6-6 in FIG. 5;

FIG. 7 is an isometric view of the steering hub of the present embodiment of the invention;

FIG. 8 is an isometric view, in section, of the steering hub of FIG. 7;

FIG. 9 is an isometric view of a friction roller assembly of the present embodiment of the invention;

FIG. 10 is an isometric view of the roller cage of the present embodiment of the invention; and

FIG. 11 is a cross sectional view along the line 11-11 in FIG. 4.

### DETAILED DESCRIPTION

The present invention will be described with reference to the accompanying drawing figures wherein like numbers represent like elements throughout. Certain terminology, for example, “top”, “bottom”, “right”, “left”, “front”, “frontward”, “forward”, “back”, “rear” and “rearward”, is used in the following description for relative descriptive clarity only and is not intended to be limiting.

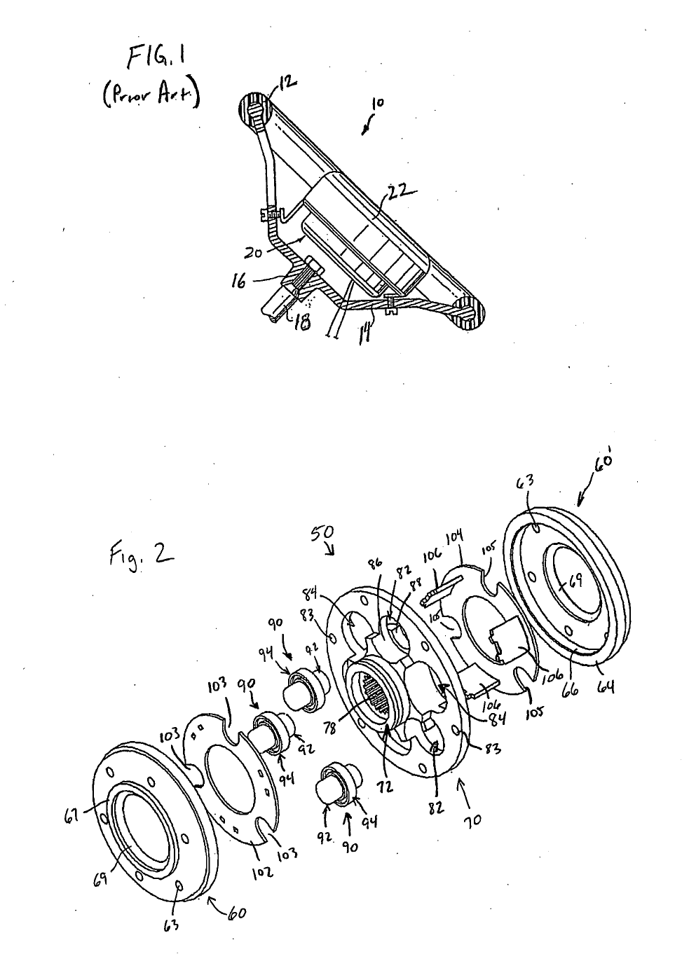

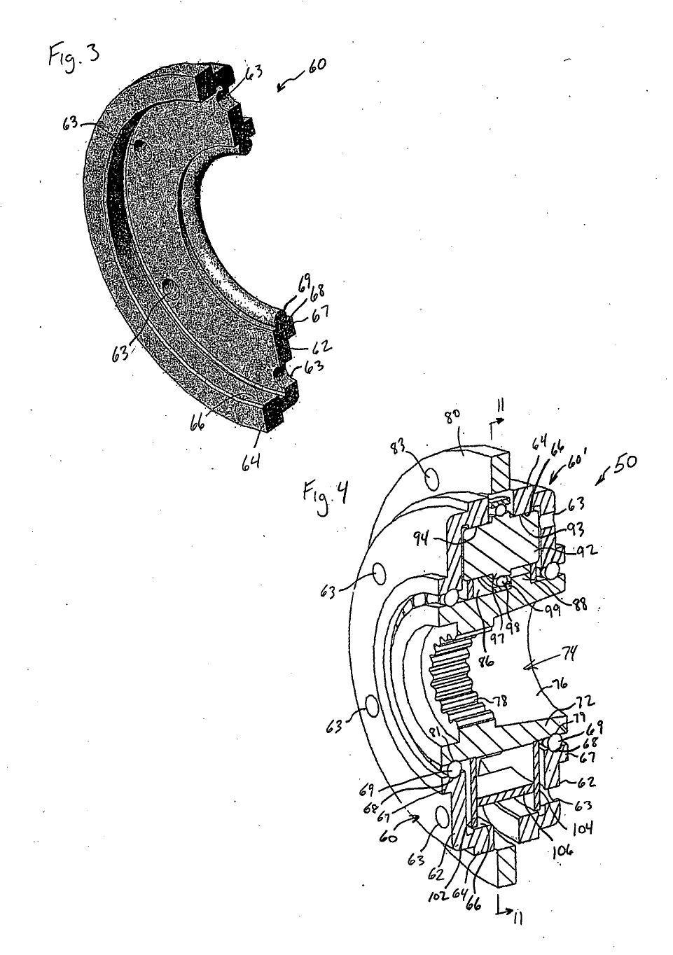

Referring to FIGS. 2-6 and 10, a mounting assembly 50 that is a first embodiment of the present invention is shown. The mounting assembly 50 generally comprises a pair of stationary rings 60, 60′, a steering hub 70, a plurality of friction roller assemblies 90 and roller cage 100. One of the stationary rings 60′ is configured for mounting to the vehicle frame (not shown). The steering hub 70 is configured to be attached to a steering shaft (not shown) and to be attached to the steering wheel (not shown). The steering hub 70 may be rotatably supported by the stationary ring 60′. The steering hub 70 in turn supports the other stationary ring 60 which is configured for supporting desired components, for example, an air bag assembly or driver controls and displays. The friction roller assemblies 90 are positioned within the steering hub 70 and provide frictional contact between the roller shaft and cylindrical raceways on the two stationary rings 60, 60′. The roller cage 100 maintains the orientation of the roller assemblies 90 and reduces skewing of the roller assemblies 90.

Exemplary stationary rings 60, 60′ will be described with reference to FIGS. 2-4. The stationary rings 60, 60′ have a radial plate 62. The radial plate 62 is provided with a plurality of holes 63. The holes 63 in the stationary ring 60′ are configured for fastening the stationary ring 60′ to the vehicle frame (not shown). The holes 63 in the stationary ring 60 are configured for mounting desired components, for example, an air bag assembly or driver controls and displays, to the stationary ring 60. Each stationary ring 60, 60′ has a first annular wall 64 extending from the radial plate 62. The inner surface of the first annular wall 64 defines a cylindrical raceway 66. The cylindrical raceway 66 of each stationary ring 60, 60′ is configured to engage the roller surfaces of the roller assemblies 90 as will be described hereinafter. Each stationary ring 60, 60′ has a second annular wall 67 extending from the other side of the radial plate 62. The inner surface of the second annular wall 67 has a concave bearing outer raceway 68 configured to receive rolling elements 69 of the ring support bearing.

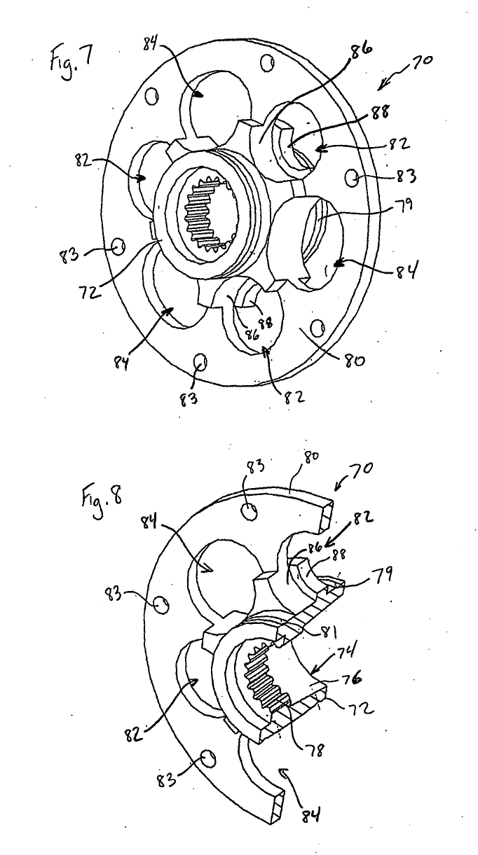

Referring to FIGS. 7-8, an exemplary steering hub 70 is shown. The steering hub 70 includes a central spindle 72 with a radial flange 80 extending outward therefrom. The central spindle 72 has a central bore 74 with a tapered surface 76 for mating with the steering shaft (not shown). The tapered surface 76 is provided with a spline portion for increasing the torque load capacity in case a heavy torque load is transferred between the steering hub 70 and the steering shaft. The outer cylindrical surface of the spindle 72 provides a concave bearing inner raceway 79, 81 on each side of the radial flange 80. The concave raceways 79, 81 are configured for receiving the rolling elements 69 of the bearings of the respective stationary rings 60, 60′. Referring to FIG. 6, the rolling elements 69 positioned between the stationary ring concave bearing outer raceway 68 and the steering hub concave bearing inner raceway 79 retain the steering hub 70, axially and radially, relative to the stationary ring 60′. The rolling elements 69 positioned between the stationary ring concave bearing outer raceway 68 and the steering hub concave bearing inner raceway 81 retain the stationary ring 60, axially and radially, relative to the steering hub 70. The steering hub 70 is thereby supported for free rotation relative to the stationary rings 60, 60′. Since the steering wheel (not shown) is connected to the radial flange 80 of the steering hub 70 and the steering shaft (not shown) is connected to the spindle 72 of the steering hub 70, rotation of the steering wheel will result in direct rotation of the steering shaft.

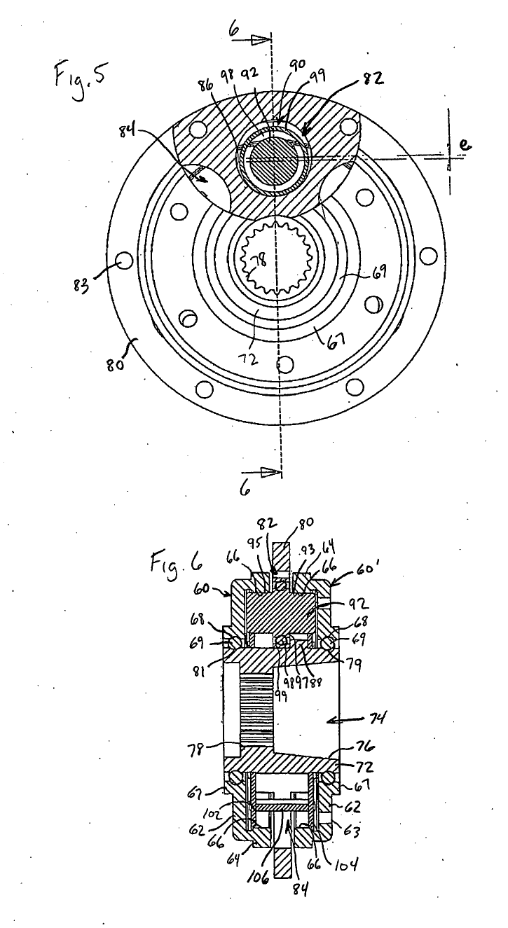

To keep the first ring 60 stationary and in phase with the second ring 60′, the steering hub 70 is configured to receive friction roller assemblies 90. There are two sets of openings 82, 84 provided through the flange 80. Each of the first openings 82 is provided with a bearing surface 86 configured to provide a bearing seat for the friction roller assemblies 90 as will be described hereinafter. As can be seen in FIG. 5, each opening 82 has a diameter greater than the outer diameter of the friction roller assembly outer bearing ring 99. A shoulder 88 is provided at the end of each bearing seat to provide an axial stop for the friction roller assemblies 90. The second openings 84 are configured to accommodate the anti-skewing roller cage 100 as will be described hereinafter. In one embodiment, there are three of each type of opening 82, 84 in alternating fashion. However, more or fewer of each type of opening 82, 84 may be provided, and they may be arranged in any desired configuration.

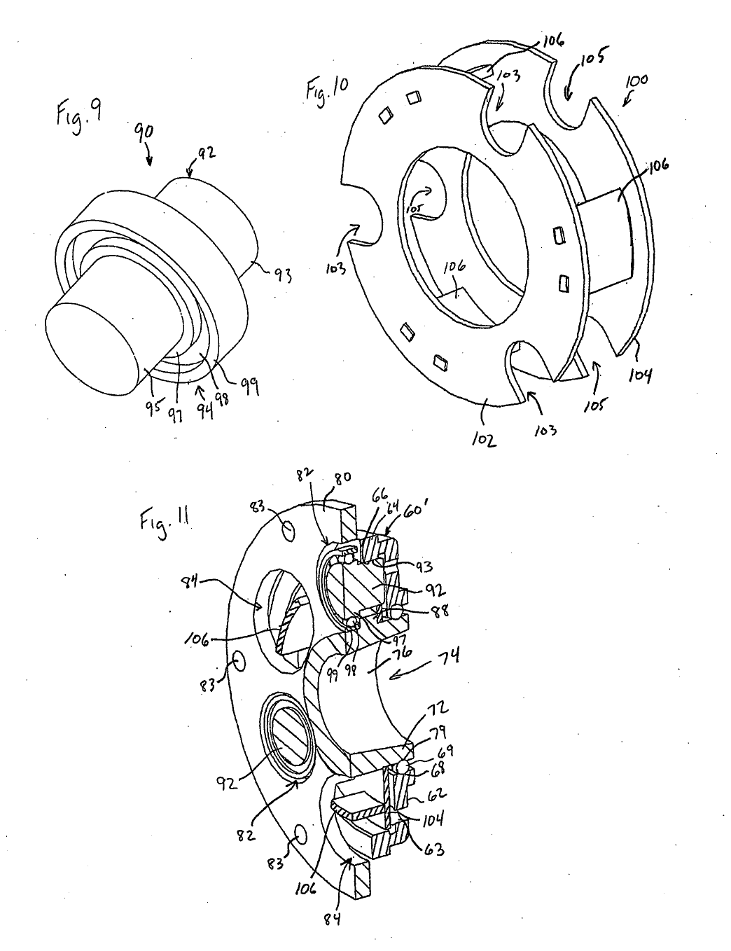

Referring to FIG. 9, an exemplary friction roller assembly 90 is shown. The friction roller assembly 90 has a shaft 92 that defines two cylindrical bearing surfaces 93 and 95. The bearing surfaces 93, 95 are configured to bear against the cylindrical raceways 66 of the stationary rings 60, 60′ as will be described hereinafter. The friction roller assembly 90 also includes an integrated bearing 94 between the two bearing surfaces 93, 95. The bearing 94 includes an inner bearing raceway 97, which can be formed integral with the shaft 92, an outer raceway 99 and rolling elements 98 positioned therebetween. The outer raceways 99 are configured to engage the first opening bearing surfaces 86 as will be described hereinafter.

Referring to FIGS. 4-6 and 11, in the fully assembled state, the friction roller assemblies 90 are positioned in the first openings 82 of the steering hub 70 with the bearing outer rings 99 seated inwardly against bearing seats 86 toward the center of the steering hub 70. The bearings 94 contact the shoulders 88 to axially position the friction roller assemblies 90. The bore diameter of openings 82 is greater than the outer diameter of bearing ring 99 such that the center of each bearing 94 is offset by a distance e from the center of the respective opening 82. Since the bearings 94 are eccentric to the center of the openings 82, and thereby the bearing seats 86, the bearing seats 86 act as a camming surface. The bearing seats 86 need not extend about the entire circumference of the openings 82, nor do the bearing seats 86 need be of circular shape. The bearing seats 86 can be of various configurations to push the bearing outer ring 99 outwardly as it rolls along the cam surface. Also, resilient components (not shown), such as leave springs, may be provided between the bearing seats 86 and bearing outer rings 99 to push the bearings 94 outwardly and preload the friction roller assemblies 90.

To minimize skewing of the friction roller assemblies 90 as the steering hub 70 is rotated, an anti-skewing roller cage 100 is assembled around the steering hub 70. As shown in FIG. 10, the anti-skewing roller cage 100 contains two plates 102, 104 and a set of side-walls 106 between the two plates 102, 104. Side-walls 106 are fixed at their ends to the plates 102, 104 to form a cage, preventing the plates 102, 104 from rotating relative to each other. Slots 103, 105, respectively, are provided in each plate 102, 104 for receiving the shafts 92 of the friction roller assemblies 90. Slots 103 on plate 102 are aligned with respective slots 105 on the other plate 104. Referring to FIGS. 4-6 and 11, in the fully assembled state, the side-walls 106 are received in the openings 84 on the steering hub flange 80. Each pair of slots 103, 105 on roller cage 100 receives a friction roller assembly 90. The cage 100 may float slightly relative to the steering hub 70 about the rotation axis. As the cage 100 floats, it rotates all the friction roller assemblies 90 with it as a unit, i.e., the cage 100 confines each friction roller assembly at both its ends in the circumferential direction, preventing the roller assembly 90 from skewing. The friction roller assembly 90, however, is free to move outwardly in the radial direction with respect to the cage 100. Relative rotation between the steering hub 70 and the cage 100 causes the friction roller assemblies 90 to be pushed radially outward by the eccentrically positioned bearings 94 with respect to the bearing seats 86. While the anti-skewing cage 100 can be employed, there are other ways to minimize skewing of the friction roller assembly shafts 92. For example, the single bearings 94 may be replaced with double bearings.

In operation, the central spindle 72 of the steering hub 70 connects to a steering shaft, and the flange 80 of the steering hub 70 connects to a steering wheel. The second stationary ring 60′ is fixed to the steering column. As the operator turns the steering wheel, the steering hub 70 tends to rotate relative to the cage 100 and friction roller assemblies 90. This produces a cam action that forces each friction roller assembly 90 to move radially outward with two cylindrical surfaces 93, 95 of the shaft 92 firmly against the two raceways 66 of the stationary rings 60, 60′. Thus, friction force between the cylindrical surfaces 93, 95, of the shaft 92 and the two raceways 66 of the stationary rings 60, 60′ is generated. The friction force at each contact enables the roller shafts 92 to roll, rather than slide, along the raceways 66 of the stationary ring 60, 60′ as the friction roller assemblies 90 orbit with the steering hub 70. The counter rotating motion of the roller shafts 92 ensures that the first ring 60 always remains in phase with the second ring 60′. Since the second ring 60′ is fixed to the steering column, the first ring 60 remains in phase and stationary with respect to the column.

While in the illustrated embodiment all of the friction roller assemblies 90 engage a camming surface and thereby all provide a frictional load, such is not required. For example, it may be desirable to have only one friction roller assembly 90 with a cam loading mechanism and the other two friction roller assemblies 90 without cam mechanisms. One such method is to fix the bearings 94 in their seats for the non-camming friction roller assemblies 90.

Embodiments of the present invention provide a friction load to keep the stationary rings 60, 60′ in phase with substantially zero backlash at frictional contacts. In particular, the friction roller assemblies 90 provide smooth and quiet operation and eliminate the lash and variation in torque experienced during operation of gear driven steering systems. Moreover, embodiments require fewer components than conventional designs.

The embodiments described above are merely exemplary embodiments, and other embodiments can be practiced that fall within the scope of embodiments of the invention.

What is claimed is:

1. A steering wheel mounting assembly, comprising:
a first stationary ring having a first bearing and a first cylindrical raceway,
a second stationary ring having a second bearing and a second cylindrical raceway and being constructed and arranged to be fixed to a vehicle frame;
a steering hub having a spindle with a radial flange extending therefrom, the spindle being constructed and arranged for connection with a steering shaft and the radial flange being constructed and arranged for connection with a steering wheel, the spindle having a first bearing raceway to engage the first bearing and a second bearing raceway to engage the second bearing, the radial flange having at least one opening that defines a bearing surface; and
at least one friction roller assembly having a shaft with a third bearing thereabout, wherein the friction roller assembly is positioned in the opening such that as the third bearing rotates relative to the bearing surface, the third bearing moves radially outward and the shaft engages the first and second cylindrical raceways.

2. The steering wheel mounting assembly of claim 1, further comprising a cage constructed and arranged to minimize skewing of the friction roller assembly.

3. The steering wheel mounting assembly of claim 2, wherein the cage comprises a plurality of plate members and a plurality of wall members between the plate members.

4. The steering wheel mounting assembly of claim 1, wherein the first stationary ring includes means for mounting at least one vehicle component.

5. A steering wheel mounting assembly, comprising:
a first stationary ring member;
a second stationary ring member constructed and arranged to be mounted to a vehicle frame;
a steering hub member having a first member and a second member, the first member being constructed and arranged to be mounted to a steering shaft, the second member being constructed and arranged to be mounted to a steering wheel; and
at least one friction roller assembly receivable by the steering hub member and comprising at least one rotatable element, the friction roller assembly being constructed and arranged to be in frictional contact with a portion of the steering hub member, a portion of the first stationary ring member, and a portion of the second stationary ring member,
wherein, in use, when the steering wheel is rotated in a first orientation, the at least one rotatable element is constructed and arranged to rotate in a second orientation counter to the first orientation, such that the first stationary ring member remains in phase with the second stationary ring member.

6. The steering wheel mounting assembly of claim 5, wherein, in use, substantially zero backlash is produced at frictional contacts within the steering wheel mounting assembly.

7. The steering wheel mounting assembly of claim 5, wherein the first member comprises a spindle and the second member comprises a radial flange extending from the spindle.

8. The steering wheel mounting assembly of claim 5, wherein the first stationary ring member has a first bearing and a first cylindrical raceway, and the second stationary ring member has a second bearing and a second cylindrical raceway.

9. The steering wheel mounting assembly of claim 8, wherein the first member has a first bearing raceway to engage the first bearing and a second bearing raceway to engage the second bearing.

10. The steering wheel mounting assembly of claim 9, wherein the second member has at least one opening that defines a bearing surface.

11. The steering wheel mounting assembly of claim 10, wherein the friction roller assembly has a shaft with a third bearing thereabout, and wherein the friction roller assembly is positioned in the opening such that, in use, as the third bearing rotates relative to the bearing surface, the third bearing moves radially outward and the shaft engages the first and second cylindrical raceways.

12. The steering wheel mounting assembly of claim 5, wherein the rotatable element comprises a shaft with a bearing thereabout.

13. The steering wheel mounting assembly of claim 5, wherein the steering wheel mounting assembly comprises at least three friction roller assemblies.

14. The steering wheel mounting assembly of claim 5, further comprising means for minimizing skewing of the friction roller assembly.

15. The steering wheel mounting assembly of claim 14, wherein the minimizing means comprise a cage.

16. The steering-wheel mounting assembly of claim 5, wherein the first stationary ring member includes means for mounting at least one vehicle component.

17. The steering wheel mounting assembly of claim 16, wherein the vehicle component comprises an air bag assembly.

18. The steering wheel mounting assembly of claim 5, wherein the steering hub member is rotatably supported by the second stationary ring member.

19. A method of producing counter rotation relative to a steering wheel, the method comprising:
providing a first stationary ring member;
mounting a second stationary ring member to a vehicle frame;
mounting a first member of a steering hub member to a steering shaft;
mounting a second member of the steering hub member to a steering wheel; and
installing at least one friction roller assembly in the steering hub member such that the friction roller assembly is in frictional-contact with a portion of the steering hub member, a portion of the first stationary ring member, and a portion of the second stationary ring member, and such that, in use, when the steering wheel is rotated in a first orientation, a rotatable element of the friction roller assembly rotates in a second orientation counter to the first orientation, such that the first stationary ring member remains in phase with the second stationary ring member.

20. The method of claim 19, further comprising installing a cage to confine at least one end of the friction roller assembly.
